(19) United States
(12) Patent Application Publication
(10) Pub. No.: US 2012/0169289 A1
(43) Pub. Date: Jul. 5, 2012

(54) BATTERY MODULE

(75) Inventors: Bong-Young Kim, Yongin-si (KR); Joon-Soo Bae, Yongin-si (KR); Young-Ho Kim, Yongin-si (KR)

(73) Assignee: Samsung SDI Co., Ltd., Yongin-si (KR)

(21) Appl. No.: 13/243,436

(22) Filed: Sep. 23, 2011

(30) Foreign Application Priority Data
Dec. 31, 2010 (KR) 10-2010-0140656

(51) Int. Cl. H02J 7/00; H01M 6/00

(52) U.S. Cl. 320/134; 29/623.1

(57) ABSTRACT

A battery module is disclosed. According to one aspect, the battery module includes: a plurality of batteries, and at least one thermistor inserted and fixed into a gap region between the plurality of batteries. The thermistor may be configured to have a variable width along an inserted direction where a size of the gap region changes. According to another aspect, a controller electrically connected to the at least one thermistor is disclosed. The controller is configured to control a charging and discharging operation of the plurality of batteries by receiving an output signal of the at least one thermistor. Accordingly, a temperature sensor is prevented from deviating its location, stability of the temperature sensor is improved, and installation of the temperature sensor is simplified.

### CROSS-REFERENCE TO RELATED APPLICATIONS

This application claims the benefit of Korean Patent Application No. 10-2010-0140656, filed on Dec. 31, 2010, in the Korean Intellectual Property Office, the disclosure of which is incorporated herein in its entirety by reference.

### BACKGROUND

1. Field

The disclosed technology relates to battery modules, and more particularly, to a battery module for supplying power, which includes a plurality of batteries.

2. Description of the Related Technology

A battery module may be used as a power storage device that electrically connects a number of batteries For example, a battery module may be configured to store power in each battery, and enable a user to use the power in each of the batteries as necessary.

The battery module may include a temperature sensor with processing circuitry so as to determine a high temperature and prevent overheating of the battery module. For example, a temperature at which the battery module would cause ignition or explosion can be sensed and prevented by monitoring temperature information of the batteries and determining if the battery module is being overheated.

### SUMMARY OF CERTAIN INVENTIVE ASPECTS

Additional aspects will be set forth in part in the description which follows and, in part, will be apparent from the description, or may be learned by practice of the described embodiments.

According to one aspect, a battery module is disclosed. The battery module comprises a plurality of batteries adjacently arranged, wherein a gap region is formed between the plurality of batteries. The battery module further includes at least one thermistor fixed within the gap region. The at least one thermistor has a variable width along a direction where a size of the gap region changes. The battery module further includes a controller electrically connected to the at least one thermistor, and configured to control a charging and discharging operation of the plurality of batteries by receiving an output signal from the at least one thermistor.

According to anther aspect, a method of assembling a battery module is disclosed. The method comprising connecting a plurality of batteries, wherein the plurality of batteries are placed adjacently to one another to form a gap region, inserting a thermistor into the gap region, wherein a front portion of the thermistor is configured to compress during insertion and expand when reaching the gap region.

### BRIEF DESCRIPTION OF THE DRAWINGS

These and/or other aspects will become apparent and more readily appreciated from the following description of the embodiments, taken in conjunction with the accompanying drawings of which:

FIG. 1 is an exploded perspective view of a battery module according to some embodiments;

FIG. 2 is a perspective view illustrating a thermistor installation, according to some embodiments;

FIG. 3 is a view of a thermistor viewed from a direction indicated by an arrow III of FIG. 3;

FIG. 4 is a cross-sectional view taken along a line IV-IV of FIG. 2;

FIG. 5 is a cross-sectional view of a thermistor installation according to some embodiments;

FIGS. 6A and 6B are views of a thermistor according to some embodiments;

FIG. 7 is a cross-sectional view illustrating an installation of the thermistor of FIG. 6 according to some embodiments;

FIGS. 8A and 8B are views of a thermistor according to some embodiments;

FIG. 9 is a cross-sectional view illustrating an installation of the thermistor of FIG. 8 according to some embodiments;

FIGS. 10A and 10B are views of a thermistor according to some embodiments;

FIG. 11 is a cross-sectional view illustrating an installation of the thermistor of FIG. 10 according to some embodiments;

FIGS. 12A and 12B are views of a thermistor according to some embodiments;

FIG. 13 is a cross-sectional view illustrating an installation of the thermistor of FIG. 12;

FIG. 14 is a view of a thermistor according to some embodiments; and

FIG. 15 is a cross-sectional view for describing how the thermistor of FIG. 14 is installed.

### DETAILED DESCRIPTION OF CERTAIN INVENTIVE EMBODIMENTS

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are described below, by referring to the figures, to explain aspects of the present description.

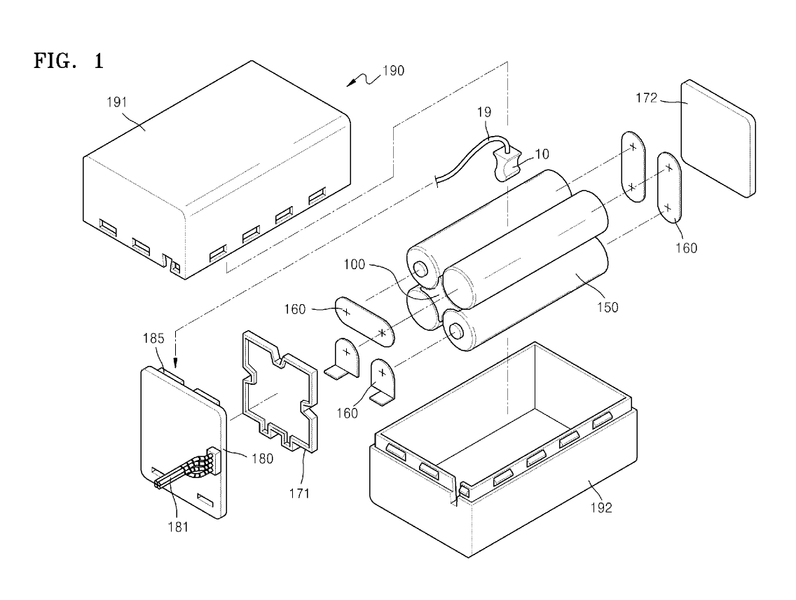

FIG. 1 is an exploded perspective view of a battery module according to some embodiments. The battery module includes a plurality of batteries 150, and a casing 190 for binding the batteries 150 into one assembled block. The battery module includes the batteries 150 connected in series or parallel according to a required output performance. For example, the batteries may be connected according to a required output voltage and output capacity of the battery module. As illustrated in FIG. 1, four batteries 150 form one assembled block. For example, the batteries 150 built in the battery module may be connected in series or in parallel. Alternatively, the batteries 150 may be connected both in series and in parallel, such that a predetermined number of batteries 150 are connected in parallel to form a sets of batteries which are connected in parallel. A first set and a second set of the batteries connected in parallel may then be connected in series to form the assembled block.

The battery module may include at least one assembled block. Additionally, the battery module may include a plurality of assembled blocks that are stacked vertically or perpendicularly, and which are electrically connected to one another. The batteries 150 forming one assembled block may be electrically connected to one another to share external input and output signals.

According to some embodiments, the batteries 150 may be cylindrical batteries. The cylindrical battery is a suitable candidate for generating a battery module of high capacity and high output at a low cost since the cylindrical battery is easily obtained. However, the battery 150 is not limited to the cylindrical battery.

The battery 150 may be a lithium-ion battery, but is not limited thereto, and may be a nickel-cadmium battery or a nickel metal hybrid battery (NiMH).

The casing 190 may define the assembling location of the batteries 150. For example, the casing 190 may include a spacer 100 disposed between the batteries 150 so as to maintain an interval between the batteries 150, and housings 191 and 192 for accommodating the batteries 150 and the spacer 100 disposed between the batteries 150. The spacer 100 may include an insulation material, and may have an approximate cross column shape extending in a direction parallel to the batteries 150. Also, a side of the spacer 100 may be formed along a part of a circumferential shape so as to adhere to the neighboring four batteries 150 having cylindrical shapes.

A lead member 160 may be disposed at each end of the battery 150. The lead member 160 is configured to connect end electrodes at ends of the batteries 150 in series and parallel. Such a series and parallel connection of the batteries 150 is not limited to those shown in FIG. 1, and may vary.

First and second end plates 171 and 172 may be disposed outside the lead member 160. For example, the first and second end plates 171 and 172 may be respectively disposed on sides of the batteries 150. The first and second end plates 171 and 172 may include insulation plates so as to insulate the lead member 160 from the external environment. A circuit board 180 may be disposed outside of at least one of the first and second end plates 171 and 172. For example, the circuit board may be disposed outside of the first end plate 171. Various electronic devices 185 for gathering state information, such as charged state or temperature of the batteries 150, and controlling charging and discharging operations of the batteries 150 may be disposed on the circuit board 180. Additionally, a circuit pattern layer (not shown) for providing traces for connecting the electronic devices 185 or lead member 160 may be formed on the circuit board 180. A wiring unit 181 may be attached to the circuit board 180, so as to communicate data with an external circuit structure (not shown), or to receive power for an external load (not shown). Additionally, the writing unit 181 may be configured to supply power from an external power supply device (not shown).

The housings 191 and 192 may provide an accommodation space for accommodating the batteries 150, and may be assembled on a top and bottom surface of the batteries 150. The housing 191 and 192 may include an opening for allowing the wiring unit 181 to protrude from the circuit board 180.

Meanwhile, in the battery module according to some embodiments, the interval between the batteries 150 is maintained and the assembling location of the batteries 150 is restricted by disposing the spacer 100 having an isolated form between the batteries 150. However, the present invention is not limited thereto. For example, the assembling location of the batteries 150 may be restricted by using a case (not shown) having a plurality of openings into which ends of the batteries 150 are inserted and fixed, or by using a case (not shown) having a rib structure defining the assembling location of the batteries 150.

Additionally, sides of the batteries 150 are exposed in the battery module in the embodiments illustrated in FIG. 1. However, the present invention is not limited thereto. For example, a cylindrical rib structure (not shown) may be formed to surround a circumferential surface of the batteries 150. In this configuration, in an embodiment in which a thermistor 10 is adhered to the surface of the battery 150 to be measured, contacts the surface of the battery 150, or is disposed between the batteries 150, the battery 150 not only includes the battery 150 itself, but may also include a rib (not shown) formed to surround the circumference of the battery.

The battery module includes at least one thermistor 10 that is closely disposed to the battery 150 and measures a temperature of the battery 150, and a battery management system (BMS) that determines a current state of the battery 150 by receiving a temperature signal from the thermistor 10. The BMS controls the charging and discharging operation of the battery 150.

The BMS may include a sensing circuit for detecting state information, such as a temperature, a current, a voltage, or the like, or the circuit board 180 including a charging and discharging protecting circuit, or the like, and the electric devices 185 built on the circuit board 180. The circuit board 180 may be a printed circuit board, on which at least one layer of circuit pattern layer (not shown) is stacked. The electric device 185 may include an integrated circuit (IC) chip, a field effect transistor (FET), a resistor, a capacitor, etc. For example, the BMS may include a circuit structure that is different than the circuit board 180 and the electric devices 185. For example, the BMS may further include an external circuit structure (not shown), which receives state information of the batteries 150 collected from the circuit board 180, and transmits a control signal to the circuit board 180 and the electric devices 185 installed on the circuit board 180.

The wiring unit 181 that externally extends may be formed on one side of the circuit board 180. The wiring unit 181 may include a power wiring connectable to an external device (not shown), or a signal wiring for transmitting or receiving a signal to and from an external circuit structure.

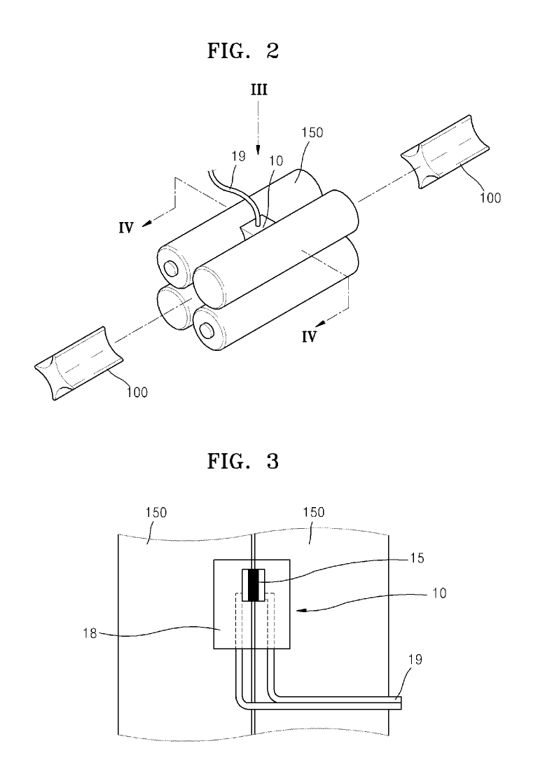

FIG. 2 is a perspective view illustrating an installation of the thermistor 10 according to some embodiments. With reference to FIG. 2, the thermistor 10 is disposed proximately to the battery 150, and may be inserted and fixed into a gap region between the batteries 150. For example, the spacer 100 for maintaining the interval between the batteries 150 may be separated into at least two small members and inserted between the batteries 150. The thermistor 10 may be inserted into the gap region where the spacer 100 is not formed, thereby avoiding physical interference between the thermistor 10 and the spacer 100 via spatial separation. However, the present invention is not limited to the embodiment illustrated in FIG. 2.

The thermistor 10 converts temperature information at a measured location to an electric signal, and transmits the electric signal to a circuit unit, such as the BMS. The thermistor 10 generates a voltage signal corresponding to a temperature of a target object. For example, the thermistor 10 may be a resistive temperature sensor in which electric resistance changes according to temperature.

A number of the thermistor 10 may correspond to a number of batteries 150 whose temperatures are to be measured. Since temperatures may be different between the batteries 150 according to their locations in the battery module of high output and high capacity, the temperatures may be detected at different locations so as to obtain accurate temperature information of each battery 150.

FIG. 3 is a view of the thermistor 10 viewed from a direction indicated by an arrow III of FIG. 3. Referring to FIG. 3, the thermistor 10 includes a thermistor chip 15, and a packing material 18 encapsulating the thermistor chip 15. The thermistor chip 15 may be a variable resistor whose resistance changes according to a temperature of a target object. The packing material 18 protects the thermistor chip 15 from an external shock and from impurities by embedding the thermistor chip 15 within the packing material 18. Additionally, the packing material 18 forms an external shape of the thermistor 10 and enables the thermistor 10 to be adhered and fixed to the battery 150.

As will be described in greater detail below, the thermistor 10 may be securely adhered between the neighboring batteries 150 due to its unique external shape. The thermistor 10 may be assembled between the batteries 150 that are arranged at regular locations, and for example, may be inserted into and fixed between the batteries 150 without having to use a separate structure for defining an assembling location of the thermistor 10.

A lead wiring 19, which receives external driving power and externally transmits an electric temperature signal, may be connected to a rear portion of the thermistor 10. A connecting portion between the thermistor chip 15 and the lead wiring 19 may be sealed and protected by the packing material 18 that forms the external shape of the thermistor 10.

Regarding installation of the thermistor 10, the batteries 150 may be fixed at regular intervals defined by the casing 190. The thermistor 10 may be inserted between the batteries 150. For example, the thermistor 10 may be pressed toward the gap region formed by the neighboring batteries 150, and may be securely supported between the batteries 150 while being inserted into the gap region.

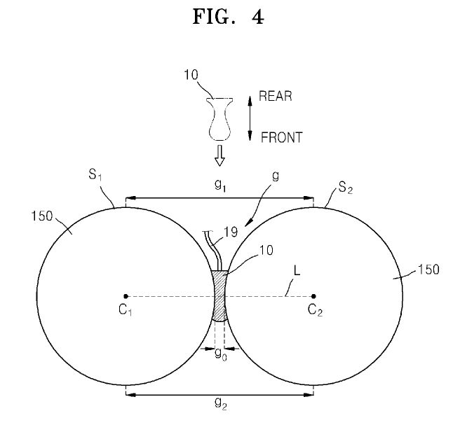

FIG. 4 is a cross-sectional view taken along a line IV-IV of FIG. 2. With reference to FIG. 4, the neighboring batteries 150 are closely disposed, and circumferential surfaces S1 and S2 of the batteries 150, which face each other, form a gap region g that is wide at the top and bottom and narrow at the center. For example, the circumferential surfaces S1 and S2 forming the external shapes of the neighboring batteries 150 form wide spaces at opening portions g1 and g2 that start to roll in a facing direction, and form a narrow space at a bottleneck portion g0.

As illustrated in FIG. 4, the opening portion g1 or g2 is a portion where the circumferential surface S1 or S2 forming the external shape of the battery 150 rotates around a circumferential center C1 or C2 while starting to roll in a direction facing the circumferential surface S2 or S1 of the neighboring battery 150, and is used to refer to a portion that starts to form the gap region g between the neighboring batteries 150. The opening portions g1 and g2 form relatively wide spaces.

Furthermore, the bottleneck portion g0 is a portion where the circumferential surfaces S1 and S2 of the neighboring batteries 150 form a minimum space, and denotes a portion that overlaps with a virtual line L connecting the circumferential centers C1 and C2. The bottleneck portion g0 forms a relatively narrow space, and corresponds to a narrowest space formed by the neighboring batteries 150. Also, an overall space from the opening portions g1 and g2 to the bottleneck portion g0 between the neighboring batteries 150 is called the gap region g.

The thermistor 10 may be inserted through the opening portion g1, and may be pressed toward the opening portion g2 opposite to the opening portion g1 so that the thermistor 10 is inserted through the bottleneck portion g0. The thermistor 10 is securely supported by the bottleneck portion g0, and is securely affixed so that the thermistor 10 does not escape from any one of the opening portions g1 and g2.

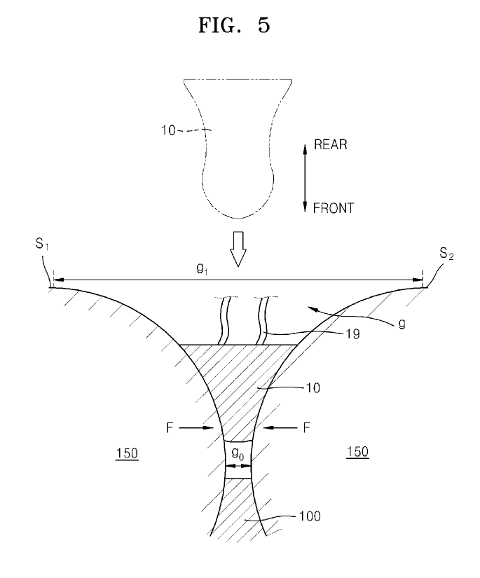

FIG. 5 is a cross-sectional view illustrating an installation of a thermistor 10 according to some embodiments. With reference to FIG. 5, the thermistor 10 is inserted into and fixed in the gap region g between the neighboring batteries 150. As illustrated in FIG. 5, the thermistor 10 is not implanted up to the bottleneck portion g0 between the neighboring batteries 150, but is implanted up to a predetermined depth from the opening portions g1 and g2. The thermistor 10 may be elastically compressed by being inserted into the gap region g between the neighboring batteries 150, and may receive an elastic bias force F from the neighboring batteries 150. Accordingly, frictional force of the thermistor 10 is increased as the thermistor 10 is adhered to the circumferential surfaces S1 and S2 of the batteries 150, and thus the thermistor 10 is securely inserted in the gap region g while being prevented from deviating from a desired location. For example, since the thermistor 10 does not enter up to the bottleneck portion g0 but is inserted into and fixed in the gap region g before the bottleneck portion g0, physical interference with the spacer 100 may be avoided, and a degree of freedom of locations of the thermistor 10 and the spacer 100 may be increased.

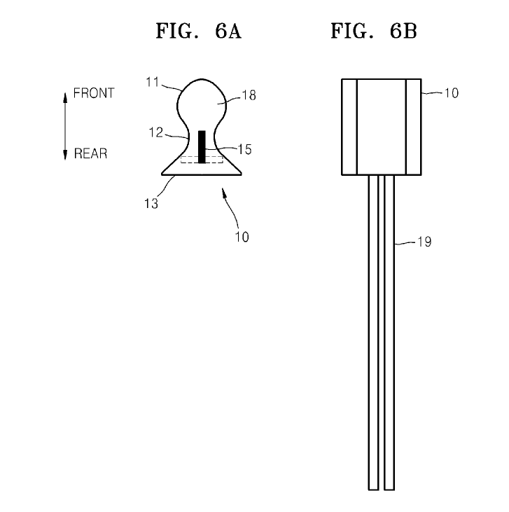

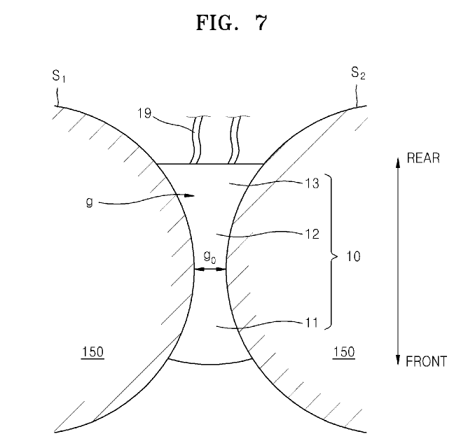

FIGS. 6A, 6B, and 7 are views of the thermistor 10 according to some embodiments. FIG. 6A is a cross-sectional view of the thermistor 10, FIG. 6B is a plan view of the thermistor 10 viewed from above, and FIG. 7 is a cross-sectional view for describing how the thermistor 10 is installed.

With reference to FIGS. 6A, 6B, and 7, the thermistor 10 may include the thermistor chip 15, and the packing material 18 sealing the thermistor chip 15. The thermistor 15 may include a variable resistor whose electric resistance changes according to temperature.

The packing material 18 forming the external shape of the thermistor 10 may be formed of a sealing resin for sealing the thermistor chip 15 therein. For example, the packing material 18 may be formed of a resin having excellent adhesive properties, and may be compacted such that it secures the thermistor chip 15. Additionally, an adhesive may also be applied to a surface of the thermistor 10 such that the thermistor 10 is further secured between the batteries 150.

Additionally, the packing material 18 may include a material having excellent adhesive properties with a material forming a side surface of the battery 150. The thermistor 10 may be securely supported between the neighboring batteries 150 due to its own shape, without the use of a separate supporter.

The packing material 18 may include an elastic body capable of elastic deformation while exhibiting buffering support for absorbing an external shock. In other words, the packing material 18 is elastically deformed while the thermistor 10 is inserted, so that the thermistor 10 is inserted into and fixed in the gap region g between the batteries 150. An example of a material forming the packing material 18 includes a silicon resin, or the like.

The thermistor 10 may be securely fixed between the neighboring batteries 150 through a compact fit. In other words, the thermistor 10 may be assembled between the batteries 150 in a compressed state, and may be inserted between the batteries 150 in an elastically biased state. Accordingly, the thermistor 10 is adhered to external surfaces of the batteries 150, and the frictional force between the surfaces of thermistor 10 and the surfaces of the batteries 150 is increased. As a result, deviation in position of the thermistor 10 within the battery module may be suppressed.

For example, the thermistor 10 may be inserted and assembled through the bottleneck portion g0 between the batteries 150, thereby performing a stopper function so that the bottleneck portion g0 and a portion of the thermistor 10 corresponding to the bottleneck portion g0 are matched and do not deviate from each other.

Additionally, if the external shape of the thermistor 10, along with the material of the thermistor 10 forming the external shape are configured to increase frictional resistance between contacting surfaces of the thermistor 10 and the battery 150, the assembled battery module including the thermistor 10 is effective in preventing deviation in the position of the thermistor 10 between the batteries 150.

The thermistor 10 may have concave sides, and may have a width that changes along a direction (front and rear direction) where a size of the gap region g changes, or along a direction (front and rear direction) where the thermistor 10 is inserted. For example, the thermistor 10 includes a narrow width portion 12 at the center, and a front portion 11 and a rear portion 13, which are enlarged from the narrow width portion 12. The front and rear portions 11 and 13 are not limited in shape as long as they are configured to be larger than the narrow width portion 12. The front and rear portions 11 and 13 are classified only for convenience of description, and do not have any specific functional difference. For example, the narrow width portion 12 is supported by the bottleneck portion g0 between the neighboring batteries 150, while the front and rear portions 11 and 13 are enlarged from the narrow width portion 12, and thus the thermistor 10 performs a stopper function so that the narrow width portion 12 does not deviate from the bottleneck portion g0 between the batteries 150.

The front portion 11 may be elastically compressed through the bottleneck portion g0, and expanded from the compressed state upon insertion. For example, the front portion 11 may be restored to an original state when exiting through an opposite side of the bottleneck portion g0. The front portion 11 may include a front end having an externally protruding convex shape.

The concave side of the thermistor 10 may be formed along a circular arc shape. The circular arc shape may correspond to an outer surface of the battery 150 having the cylindrical shape. For example, the concave side of the thermistor 10 may have a circular arc shape having a suitable radius of curvature.

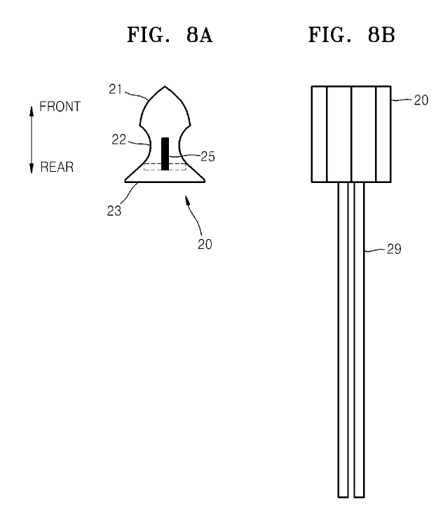

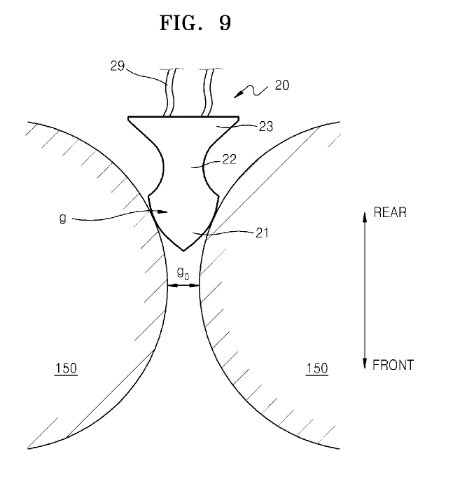

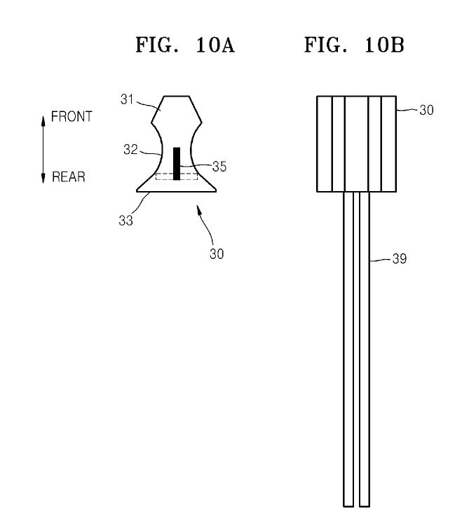

FIGS. 8A, 8B, and 9 are views of a thermistor 20 according to some embodiments. FIG. 8A is a cross-sectional view of the thermistor 20, FIG. 8B is a plan view of the thermistor 10 viewed from above, and FIG. 9 is a cross-sectional view illustrating an installation of the thermistor 20 of FIG. 8.

With reference to FIGS. 8A, 8B, and 9, the thermistor 20 is inserted into and assembled in the gap region g between the batteries 150. The thermistor 20 has a variable width along a direction (front and rear direction) where the size of the gap region g changes, or along a direction (front and rear direction) where the thermistor 20 is inserted.

For example, the thermistor 20 has concave sides, and includes a narrow width portion 22 at the center, and a front portion 21 and a rear portion 23, which are enlarged from the narrow width portion 22. The front and rear portions 21 and 23 are not limited as long as they are formed to be larger than the narrow width portion 22. The front and rear portions 21 and 23 are classified only for convenience of description, and do not have any specific functional difference. For example, the narrow width portion 22 is supported by the bottleneck portion g0 between the neighboring batteries 150, while the front and rear portions 21 and 23 are enlarged from the narrow width portion 22. As a result, the thermistor 20 performs a stopper function so that the narrow width portion 22 does not deviate from the bottleneck portion g0 between the batteries 150.

For example, when the thermistor 20 is inserted between the batteries 150, the front portion 21 may be disposed at a front end of the inserted direction. Additionally, a lead wire 29 may be taken out through the rear portion 23. While the thermistor 20 is inserted into the gap region g between the batteries 150, the thermistor 20 may be elastically deformed so as to pass through a narrow space. Specifically the bottleneck portion g0, between the batteries 150, and considerable resistance may be applied to the front end of the thermistor 20 when the thermistor 20 enters the bottleneck portion g0 due to frictional resistance of the thermistor 20 sliding between the batteries 150. Accordingly, the rear portion 23 from which the lead wiring 29 protrudes may be disposed at the back surface of the thermistor 20 while inserting the thermistor 20. Additionally, the thermistor chip 25 may provided within a body of the thermistor 20.

With reference to FIG. 9, the front portion 21 is configured to be larger than the narrow width portion 22 while the front end of the front portion 21 has a wedge shape. A wedge shape may enable the thermistor 20 to be easily inserted into the gap region g between the batteries 150. In other words, by forming the front portion 21 as a wedge shape, the front portion 21 easily penetrates a space between the neighboring batteries 150 while the thermistor 20 is inserted. As a result, a resistance during installation of the thermistor 20 is reduced, and installation operability of the thermistor 20 is improved.

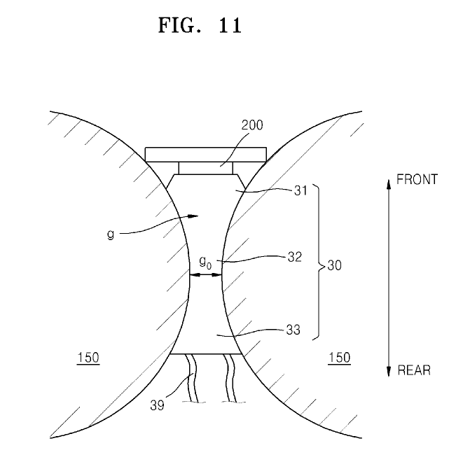

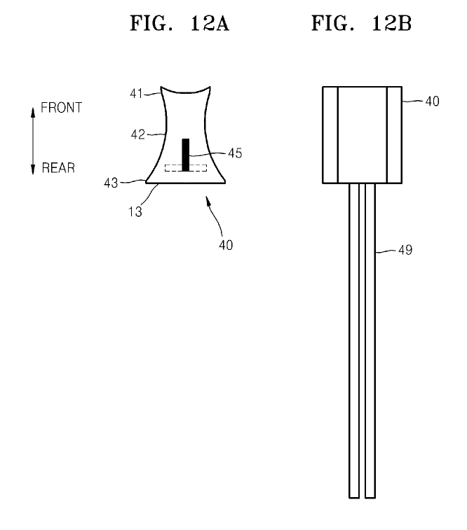

FIGS. 10A, 10B, and 11 are views of a thermistor 30 according to some embodiments. FIG. 10A is a cross-sectional view of the thermistor 30. FIG. 10B is a plan view of the thermistor 30 viewed from above. FIG. 11 is a cross-sectional view illustrating installation of the thermistor 30 of FIG. 10.

With reference to FIGS. 10A, 10B, and 11, the thermistor 30 is securely supported between the batteries 150 by being inserted into and assembled in the space between the batteries 150. The thermistor 30 is secured by being inserted into the gap region g between the batteries 150. The thermistor 30 has a variable width along a direction (front and rear direction) where the size of the gap region g changes, or along a direction (front and rear direction) where the thermistor 30 is inserted.

For example, the thermistor 30 includes a narrow width portion 32 at the center having the narrowest width, and a front portion 31 and a rear portion 33. The front portion 31 and the rear portion 33 extend from the narrow width portion 32 while being enlarged. As illustrated in FIG. 10A, the front portion 31 has a truncated wedge shape having a cut tip. Accordingly, a front part of the front portion 31 is not sharp, but exhibits a blunt shape corresponding to a planar surface. A lead wiring 39 extends from a back surface of the thermistor 30. A thermistor chip 35 is housed within a body of the thermistor 30.

With reference to FIG. 11, a circuit unit 200 may be disposed in a space between the neighboring batteries 150 while the thermistor 30 is installed in the gap region g. Spatial efficiency may be improved by installing various wirings or flexible printed circuit board having a wiring pattern and circuit parts, by using free space between the batteries 150. Here, a tip of the thermistor 30 is formed as a flat surface. As a result, the circuit unit 20 disposed in the space between the batteries 150 may be stably supported.

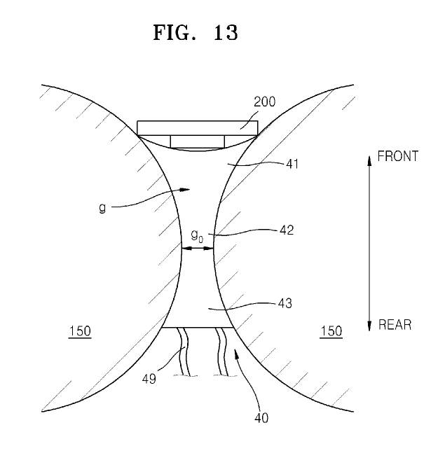

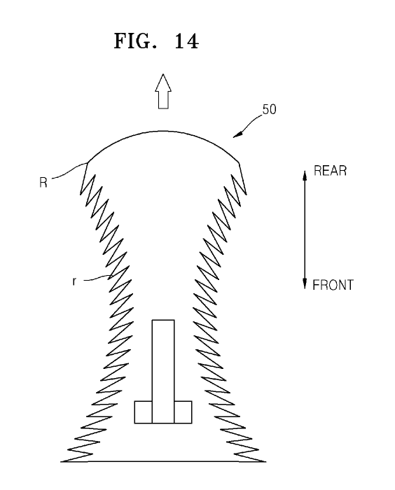

FIGS. 12A, 12B, and 13 are views of a thermistor 40 according to some embodiments. FIG. 12A is a cross-sectional view of the thermistor 40. FIG. 12B is a plan view of the thermistor 40 viewed from above. FIG. 13 is a cross-sectional view illustrating an installation of the thermistor 40 of FIG. 12.

With reference to FIGS. 12A, 12B, and 13, the thermistor 40 is inserted into and assembled in the gap region g between the neighboring batteries 150. The thermistor 40 is configured to have a variable width along a direction (front and rear direction) where the size of the gap region g changes, or a direction (front and rear direction) where the thermistor 40 is inserted between the batteries 150.

For example, the thermistor 40 includes a narrow width portion 42 at the center having concave sides, and a front portion 41 and a rear portion 43, which extend and are enlarged from the narrow width portion 42. The front portion 41 may be disposed at a front end in an inserted direction while being installed between the batteries 150. A lead wiring 49 may protrude through the rear portion 43.

The front portion 41 is formed as a concave shape. The concave shape of the front portion 41 may form an accommodation portion for accommodating the circuit unit 200. Following the installation of the thermistor 40, various wiring components and/or a flexible printed circuit board having a trace patterns and circuit parts may be installed in the space between the neighboring batteries 150. Accordingly, the battery module may be miniaturized and compacted by using the space between the batteries 150, which was not previously utilized. As illustrated in FIG. 13, since the concave shape of the front portion 41 of the thermistor 40 provides the accommodation portion for accommodating the circuit unit 200, or the like, the circuit unit 200 is installed in the accommodation portion that is concave. Accordingly, not only the circuit unit 200 is stably supported, but additionally, the circuit unit 200 does not protrude from the surface of the battery 150 even if a size of the circuit unit 200 is increased. A thermistor chip 45 is housed within a body of the thermistor 40.

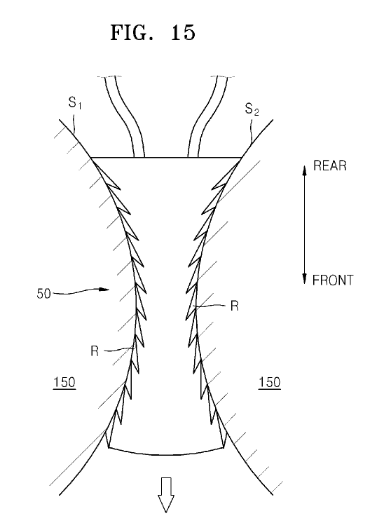

FIGS. 14 and 15 are views of a thermistor 50 according to some embodiments. FIG. 14 is a cross-sectional view of the thermistor 50. FIG. 15 is a cross-sectional view illustrating an installation of the thermistor 50 of FIG. 14. With reference to FIGS. 14 and 15, a surface of the thermistor 50, which faces the battery 150 may be a rough surface R. For example, sides that contact the circumferential surfaces 51 and S2 of the batteries 150 may be configured as rough surfaces R. As illustrated in FIG. 14, the rough surface R are rough so as to improve frictional force with the battery 150 that is to be contacted.

In the current embodiment shown in FIG. 14, the rough surface R may include a plurality of protrusions r obliquely extending in a diagonal direction. Here, the protrusions r may obliquely extend along the diagonal direction in a front and rear direction. The protrusions r may be formed to have directivity in such a way that the protrusions r lie down to reduce entrance resistance when the thermistor 50 is inserted, and stand up to increase resistance when the thermistor 50 deviates backward. When the thermistor 50 is inserted, the battery 150 is drawn near to the surface of the thermistor 50 where the protrusions r are formed with respect to the thermistor 50. The protrusions r may tilt in a direction where the battery 150 is drawn near to the surface of the thermistor 50.

In FIGS. 14 and 15, the surface of the thermistor 50 contacting the battery 150 is configured as a rough surface R. However, the whole or any part of the thermistor 50 may have the rough surface R. For example, a rough surface may be formed on a portion where resistance may be increased as the thermistor 50 contacts the battery 150 while being deviated, even on a portion which does not contact the battery 150 when the thermistor 50 is completely assembled. For example, the rough surface R may be formed on a front portion of the thermistor 50.

According to a comparative example, a thermistor is placed on a surface of a battery and is fixed to the surface by coating a molding resin on the thermistor placed on the surface. An adhesive tape is coated on an outer side of the thermistor. However, according to the comparative example, the operability of the battery module is low since the molding resin and the adhesive tape are coated on a cylindrical surface of the battery. As a result, during operation, the thermistor may deviate from the surface of the battery since the adhesion of the molding resin and the adhesive tape is affected by the heat generated during operation of the battery module.

Alternatively, according to the some embodiments, since the thermistors 10 through 50 are inserted into and fixed in the gap region g between the batteries 150, deviation of the thermistors 10 through 50 is suppressed regardless of an effect of heating of the battery 150. Additionally, operability of the installation operation is improved since the thermistors 10 through 50 are mounted in the gap region g between the batteries 150 and then pressurized in order to complete the installation of the thermistors 10 through 50.

As described above, according to one or more of the above embodiments, a structure of a temperature sensor is improved such that it may be inserted and fixed through a bottleneck portion between batteries. Therefore, operability of an installation operation is improved since the temperature sensor is suppressed from deviating from the a desired position despite the affect of heating of the batteries. Additionally, installation of the temperature sensor is completed by mounting the temperature sensor in a gap region between the batteries and pressing the temperature sensor at one time.

One or more embodiments describe above include a battery module, wherein a temperature sensor is prevented from deviating its position. As a result, stability of the temperature sensor is improved.

One or more embodiments of the present invention include a battery module, wherein an operation of installing a temperature sensor is simplified.

According to some embodiments, a battery module is disclosed. The battery module comprises a plurality of batteries adjacently arranged, wherein a gap region is formed between the plurality of batteries. The battery module further includes at least one thermistor fixed within the gap region, the at least one thermistor having a variable width along a direction where a size of the gap region changes, and a controller electrically connected to the at least one thermistor, and configured to control a charging and discharging operation of the plurality of batteries by receiving an output signal from the at least one thermistor.

The at least one thermistor may be inserted and fixed through a bottleneck portion between neighboring batteries. The thermistor may have a narrow width portion corresponding to the bottleneck portion.

A surface of the at least one thermistor, which faces the plurality of batteries, may include a concave surface or an arc-shaped surface. Alternatively, a surface of the at least one thermistor, which faces the plurality of batteries, may include a rough surface. For example, the rough surface may include a plurality of protrusions.

The thermistor may include: a center portion having a narrow width; a rear portion extending from the center portion and having a larger width from than the center portion and from which at least one lead wire protrudes; and a front portion extending from the center portion and configured to have a larger width than the width of the center portion and formed on a location opposite to the rear portion.

The narrow width portion at the center may have the narrowest width through the thermistor. The front portion of the thermistor may include a front end having a convex shape that externally protrudes.

The front portion of the thermistor may include a front end having a wedge shape. The front portion of the thermistor may include a tapered shape, wherein a tip portion is formed as a flat surface.

The front portion of the thermistor may include a front end having a concave shape. The thermistor may include: a thermistor chip; and a packing material surrounding and sealing the thermistor chip.

According to one or more embodiments of the present invention, a battery module includes: a plurality of batteries; a casing for defining an assembling location of the plurality of batteries, and at least one thermistor inserted and fixed into a gap region between the plurality of batteries, and having a variable width along an inserted direction where a size of the gap region changes, and a circuit board electrically connected to the at least one thermistor.

The at least one thermistor may be inserted and fixed through a bottleneck portion between neighboring batteries. The thermistor may include: a narrow width portion at a center; a rear portion extending to have an enlarged width from the narrow width portion and from which a lead wiring is taken out; and a front portion extending to have an enlarged width from the narrow width portion and formed on a location opposite to the rear portion.

A surface of the at least one thermistor, which faces the plurality of batteries, may include a concave surface. A surface of the at least one thermistor, which faces the plurality of batteries may include a rough surface. The rough surface may include a plurality of protuberances protruding along one direction from the surface of the thermistor.

According to some embodiments, a method of assembling a battery module is disclosed. The method comprising connecting a plurality of batteries, wherein the plurality of batteries are placed adjacently to one another to form a gap region, inserting a thermistor into the gap region, wherein a front portion of the thermistor is configured to compress during insertion and expand when reaching the gap region.

It should be understood that the exemplary embodiments described herein should be considered in a descriptive sense only and not for purposes of limitation. Additionally, descriptions of features or aspects within each embodiment should be considered as available for other similar features or aspects in other embodiments.

What is claimed is:

1. A battery module comprising:
a plurality of batteries adjacently arranged, wherein a gap region is formed between the plurality of batteries;
at least one thermistor fixed within the gap region, the at least one thermistor having a variable width along a direction where a size of the gap region changes; and
a controller electrically connected to the at least one thermistor, and configured to control a charging and discharging operation of the plurality of batteries by receiving an output signal from the at least one thermistor.

2. The battery module of claim 1, wherein the at least one thermistor is inserted and fixed through a bottleneck portion between the adjacent batteries, and wherein the at least one thermistor has a narrow width portion corresponding to the bottleneck portion.

3. The battery module of claim 1, wherein a surface of the at least one thermistor, which faces the plurality of batteries, comprises a concave surface.

4. The battery module of claim 1, wherein a surface of the at least one thermistor, which faces the plurality of batteries, comprises a circular arc shaped surface.

5. The battery module of claim 1, wherein a surface of the at least one thermistor, which faces the plurality of batteries, comprises a plurality of protrusions.

6. The battery module of claim 1, wherein the thermistor comprises:
a front portion;
a rear portion formed opposite to the front portion; and
a center portion between the front portion and the rear portion, wherein a width of the front portion and the rear portion is greater than a width of the center portion; and wherein at least one lead wire protrudes from the rear portion.

7. The battery module of claim 6, wherein a middle region of the center portion has the narrowest width of the thermistor.

8. The battery module of claim 6, wherein the front portion of the thermistor comprises a front end having a convex shape that externally protrudes.

9. The battery module of claim 6, wherein the front portion of the thermistor comprises a front end having a wedge shape.

10. The battery module of claim 6, wherein the front portion of the thermistor comprises a tapered shape, and wherein a tip portion of the tapered shape is formed as a flat surface.

11. The battery module of claim 6, wherein the front portion of the thermistor comprises a front end having a concave shape.

12. The battery module of claim 1, wherein the thermistor comprises:
a thermistor chip; and
a packing material surrounding and sealing the thermistor chip.

13. The battery module of claim 1, further comprising a casing configured to define assembling locations of the plurality of batteries.

14. The battery module of claim 1, wherein a surface of the thermistor contacting the plurality of batteries is configured to have a rough shape.

15. The battery module of claim 5, wherein the protrusions extend in a diagonal direction from a surface of the thermistor.

16. A method of assembling a battery module, the method comprising:
connecting a plurality of batteries, wherein the plurality of batteries are placed adjacently to one another to form a gap region; and
inserting a thermistor into the gap region, wherein a front portion of the thermistor is configured to compress during insertion and expand when reaching the gap region.

17. The method of claim 16, further comprising forming a housing over the plurality of batteries.

18. The method of claim 16, further comprising forming a circuit unit on a back portion of the thermistor, wherein the circuit portion is formed between adjacent batteries.

19. The method of claim 16, further comprising applying an adhesive to at least one surface of the thermistor prior to inserting the thermistor into the gap region.

20. The method of claim 16, wherein a surface of the thermistor contacting the plurality of batteries is configured to have a rough shape.
